(19) United States
(12) Patent Application Publication
(10) Pub. No.: US 2014/0272256 A1
(43) Pub. Date: Sep. 18, 2014

(54) ROTATIONALLY MOLDED PRODUCT WITH EMBEDMENT AND RELATED APPARATUS AND METHOD FOR FABRICATING SAME

(71) Applicants: Deborah Langheld, Manassas, VA (US); Jeffrey Ensminger, Manassas, VA (US)

(72) Inventors: Deborah Langheld, Manassas, VA (US); Jeffrey Ensminger, Manassas, VA (US)

(73) Assignee: Commonwealth Technology, Inc., Alexandria, VA (US)

(21) Appl. No.: 13/804,737

(22) Filed: Mar. 14, 2013

(51) Int. Cl. B29C 41/04

(52) U.S. Cl. CPC B29C 41/04
USPC 428/76; 264/114; 425/110; 264/643

(57) ABSTRACT

Various embodiments of a rotationally molded product and related apparatuses and methods are disclosed. For example, a method of encapsulating a foreign object in a rotationally molded product may include forming a pre-layer on a surface of a mold of a rotational molding machine, placing a foreign object on the pre-layer, loading a first charge of powder material in the mold, and rotating the mold while applying heat to the mold to form a first layer on the foreign object. The foreign object may be fully encapsulated between the pre-layer and the first layer.

Government funding was involved in the development of this invention. The Government has certain rights in this invention.

### FIELD OF THE INVENTION

The present disclosure relates generally to the field of rotational molding. More specifically, particular embodiments of the present disclosure relate to rotationally molded products and related apparatuses and methods for fabricating the same.

### DESCRIPTION OF RELATED ART

Rotational molding is a manufacturing process used to produce structures of virtually any size and shape. The structures may be plastic or other types of materials. The structures are typically light-weight and hollow, but are not necessarily so. Rotational molding may involve rotating a mold, loaded with a charge of fusible material in a powder form. The mold may be rotated slowly around one, two, or more axes in a heated oven. The mold may be custom-designed or not. Heat from the oven may cause the powder material to melt and adhere to the inside surface of the mold. After the powder material has melted and adhered to the mold, the mold may be transferred to a cooling environment to have the molded product solidify and/or cool. When the molded structure is sufficiently solidified and/or cooled, the mold may be opened and the molded product removed from the mold.

Rotational molding may involve embedding a foreign object into a wall of a molded product. This type of embedment has been previously done by placing a mounting feature in the mold before loading a charge of powder material and melting the material so as to fix the foreign object in the mold during a rotational molding process. Since the mounting feature requires structural support, the mounting feature is typically connected to an inside surface of the mold. As a result, the embedded foreign object is exposed externally on at least one surface of the finished molded product. The exposed portion typically corresponds to a contact area between the mounting feature and the inside surface of the mold.

Further, the wall thickness that accrues over the foreign object may correspond to the heat profile of the foreign object, resulting in a cosmetic bump where the foreign object is located. For example, if a foreign object has a thermal conductivity substantially higher than that of an adjacent mold surface, the powder material in contact with the foreign object in the mold cavity may reach a tack temperature (e.g., the material-specific temperature at which the powder material melts and adheres to an object) earlier than it does around the mold surface, resulting in a greater amount of powder material adhering to the foreign object than the mold surface. Conversely, if a foreign object has a substantially lower thermal conductivity than that of an adjacent mold surface, the powder material in contact with the foreign object may reach a tack temperature later than it does around the mold surface, resulting in a relatively thin wall around the foreign object. Therefore, care may need to be taken to match the conductivity of the foreign object with that of the adjacent surface of the mold and/or to synchronize the rate of heating between the mold and the foreign object in order for the powder material to uniformly adhere to both the mold surface and the foreign object.

### SUMMARY

Various exemplary embodiments of the present disclosure may provide improved rotational molding apparatuses and/or methods for embedding a foreign object in a wall of a molded product without requiring a mounting feature to secure the foreign object in the mold. Exemplary embodiments may enable producing a finished molded product having the foreign object fully encapsulated inside its wall without any externally exposed portion thereon.

As embodied and broadly described herein, one exemplary aspect of the invention may provide a method of encapsulating a foreign object in a rotationally molded product. The method may include forming a pre-layer on a surface of a mold of a rotational molding machine, placing a foreign object on the pre-layer, loading a first charge of powder material in the mold, and rotating the mold while applying heat to the mold to form a first layer on the foreign object. The foreign object may be fully encapsulated between the pre-layer and the first layer.

According to another exemplary aspect, forming the pre-layer may include applying a powdered pre-layer material to a region of the mold at which the foreign object is to be placed, and heating the powdered pre-layer material to form the pre-layer on the region of the mold. The powdered pre-layer material and the first charge of powder material may be substantially the same material.

In some exemplary aspects, the method may further include, after placing the foreign object on the pre-layer, applying a fixing layer on a portion of the foreign object to fix the foreign object onto the pre-layer. Applying the fixing layer may include applying a powdered fixing layer material to an edge or corner of the foreign object and applying heat to the powdered material applied to the edge or corner. The powdered fixing layer material and the first charge of powder material may be substantially the same material.

According to still another exemplary aspect, the method may further include loading a second charge of powder material to the mold to form a second layer above the first layer. Loading the second charge of powder material may occur after the first layer has completed sintering but prior to a completion of polymerization so as to allow bubbles in the first layer to migrate. The first charge of powder material and the second charge of powder material may be different from each other.

In yet still another exemplary aspect, the method may further include enclosing the foreign object with an enclosure and substantially filling the enclosure with a potting material. The enclosure may include fiberglass fabric.

Various exemplary aspects of the present disclosure may also provide a rotationally molded product that includes a wall and a foreign object fully encapsulated within the wall without any portion being exposed externally through the wall. The foreign object may include an electronic device and an enclosure substantially enclosing the electronic device. The enclosure may be filled with potting material.

In another exemplary aspect, the enclosure may include a multi-layered stiffener configured to protect the electronic device. In still another exemplary aspect, the foreign object may include an opaque material.

In accordance with some exemplary aspects, an oven-less rotational molding machine may be provided. The molding machine may include a molding platform rotatably received in a housing frame, a mold disposed in the molding platform, and a heater disposed in the molding platform to apply heat to at least a portion of the mold.

In some exemplary aspects, the heater may be configured to heat different portions of the mold with different temperature profiles.

According to still another exemplary aspect, the molding machine may further include a plurality of thermal sensors installed within or on the walls of the mold to measure a temperature of the mold.

In yet still another exemplary aspect, the molding machine may further include a cooler disposed in the molding platform to cool at least a portion of the mold.

Additional objects and advantages of the invention will be set forth in part in the description which follows, and in part will be obvious from the description, or may be learned by practice of the invention. Certain objects and advantages of the invention will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various exemplary embodiments of the invention and together with the description, serve to explain various principles and aspects of the invention.

FIG. 1 is a flow chart illustrating a method of fully encapsulating a foreign object in a wall of a rotationally molded product, according to one exemplary embodiment of the present disclosure.

FIG. 2 is a schematic illustration of an exemplary method of controlling the timing for using multiple charges of powder materials.

FIG. 3 is a cross-sectional view of an exemplary rotationally molded product made by the method illustrated in FIG. 1.

FIG. 4 is a schematic illustration of an electronic device prepared for encapsulation, according to one exemplary embodiment.

FIG. 5 is a perspective view of an oven-less rotational molding machine with an integrated mold, according to one exemplary embodiment.

FIG. 6 is a perspective view of the mold shown in FIG. 5, where the mold body is shown translucent to illustrate an exemplary heater arrangement in the mold.

FIG. 7 is a schematic illustration of the relationship between a plastic wall thickness accrued on an interior surface of a mold and the interior mold surface temperature during a powder accrual phase.

FIG. 8 is a schematic illustration of a passive apparatus for regulating the pressure and temperature of a mold during a rotational molding process, according to one exemplary embodiment.

FIG. 9 is a schematic illustration of an active apparatus, integrated within a rotational molding apparatus, for regulating the pressure and temperature of a mold during a rotational molding process, according to another exemplary embodiment.

### DESCRIPTION OF EXEMPLARY EMBODIMENTS

Reference will now be made in detail to exemplary embodiments consistent with principles and aspects of the present invention, examples of which are illustrated in the accompanying drawings. Wherever possible, the same reference numbers will be used throughout the drawings to refer to the same or like parts.

One exemplary aspect of the present disclosure is directed to a manufacturing process that allows a foreign object to be fully encapsulated inside a wall of a rotationally molded product without requiring any physical mounting feature to hold the foreign object during a rotational molding process. This allows the rotationally molded product to have no, minimal, or reduced cosmetic indication of the location of the foreign object. Further, the disclosed process may allow a wide variety of foreign objects to be encapsulated irrespective of their thermal properties.

The term “fully encapsulated,” as used herein, refers to a condition in which an object is completely embedded in a surrounding material without any portion of the object being exposed externally on a surface of the surrounding material.

FIG. 1 illustrates a general process for fully encapsulating a foreign object in a wall of a rotationally molded product, according to one exemplary embodiment of the present disclosure. The foreign object may include, but is not limited to, a structural reinforcement (e.g., a plate, a rib, or any other stiffening member) and an electronic component (e.g., a sensor, an antenna, a battery, an induction coil, a RFID chip, a printed circuit board, etc.).

Referring to FIG. 1, the process may start with applying a first powder material in a specific mold region of a mold cavity at which the foreign object is to be located (step S10). Depending on the characteristics of the desired final product, a wide variety of powder material can be used. For example, the powder material may include, but not be limited to, polyethylene (e.g., LDPE, LLDPE, MDPE, HDPE, XLPE, mLLDPE, EVA, EBA, etc.), polypropylene, polyvinyl chloride, polyesters, nylon, polycarbonate, ABS, flouropolymers, polystyrene, and polyurethane. In some exemplary embodiments, the powder material may include metallic and/or ceramic materials. The powder material may be in fine grain form, pellet form, loose form, or other form compatible with rotational molding.

The first powder material may be heated to a predetermined temperature to form a pre-layer in the specific mold region (step S12). The pre-layer may constitute an external layer between the foreign object and the external surface of the finished product. The amount of first powder material applied may depend on the desired thickness of the pre-layer. In some exemplary embodiments, the first powder material may be heated just below tack temperature. The term “tack temperature,” as used herein, refers to the temperature at which the powdered material used adheres to the interior mold surface and, therefore, different powder material may have different tack temperatures.

When a high percentage (e.g., about 85 to 100 vol. %) of the first powder material has exceeded the glass transition temperature, which is the temperature at which the amorphous powder material in the solid state transitions to a viscous, soft material, the foreign object may be placed on a desired location of the pre-layer (step S14). A light pressure may be applied on the foreign object toward the pre-layer. Alternatively, the first powder material may be heated just enough to allow the foreign object to be placed on the pre-layer.

After the foreign object is placed on the pre-layer, an amount of second powder material can be applied to the edge and/or corner portions of the foreign object (step S16). The second powder material may be the same material as the first powder material. Alternatively, the second powder material may be different from the first powder material. In another exemplary embodiment, an adhesive material may be used instead of or in addition to the second powder. Heat may be applied to the second powder material until it reaches the glass transition temperature or sufficiently to lock the foreign object into place (step S18). A heater, such as a torch or an infrared heater, may be used to manually direct the heat toward the second powder material. Alternatively or additionally, any other suitable heating device can be used to apply the heat.

Immediately or sometime after the foreign object is locked in place on the pre-layer, a first charge of powder material may be loaded inside the mold (step S20). The first charge of powder material may be the same as, or different from, the first powder material in step S10 or the second powder material in step S16. After the powder material is loaded, the mold may be closed, and the rotation of the mold may begin in a controlled rotational molding machine.

During this rotational molding process, the charge of powder material adheres to the inside surface of the mold and the foreign object. The term “rotating a mold,” as used herein in conjunction with a rotational molding machine, refers to, for example, rotating a mold about at least one rotational axis in a manner such that the powder material is consumed and adheres to a surface of the mold. The powder material may adhere to the surface substantially uniformly. In some exemplary embodiments, the powder material may adhere to the surface non-uniformly. For example, the mold may be provided with a special arrangement (e.g., varying the speed of armature and/or molding plate so as to move the mold non-uniformly or providing heat to a specific location of the mold) that prevents the powder material from uniformly adhering to the surface of the mold.

After a predetermined, calculated period of time, a second charge of powder material may be loaded into the mold (step S22) to form an additional layer of material. The second charge may be directly loaded into the mold from a container or a chute without opening the mold. An example of such a molding machine that enables the direct loading is described later with reference to FIG. 9. The second charge of powder material may be the same as or different from the first charge of powder material.

Step S20 and/or step S22 may be repeated as many times as desired or necessary. For example, the number of subsequent charges may depend upon the size of the foreign object and the degree of cosmetic blending desired. The temperatures and durations of the heating cycle for each charge may be determined from the size of the foreign object and the individual layer thicknesses desired.

Steps S20 and S22 may be performed using a conventional rotational molding machine, such as a carousel-style machine with a furnace oven. Alternatively, an oven-less rotational molding machine described later with reference to FIGS. 5 and 6 of the present disclosure may be used.

While step S22 may be omitted and step S20 can be carried out with a full load of powder material, these multiple layering steps S20 and S22 may facilitate the embedment of the foreign object into the middle of the wall with full encapsulation on all sides and cosmetic blending around it. Separating the full charge into a plurality of separate charges of layer material may improve control of the polymer morphology within the wall at various depths.

For example, the disclosed multiple layering steps may allow the rheology of the polymer melt to be controlled around the foreign object, both inside and outside the rotationally molded product. When molding a thermoset plastic, the polymerization may be achieved through a combination of the amount of heat applied and duration applied. Molecular chain conformations may affect the resulting mechanical properties around the foreign object. But, the foreign object itself may disrupt the uniformity of heat penetration required for a uniform layer of plastic accrual, as well as uniform polymer morphology. If the layer covering the foreign object is too thin, stress cracks can occur. Further, a non-uniform morphology around the foreign object may shrink differently, also resulting in stress cracks. Additionally, after the powdered material accrues on the mold surface, they may begin sintering, and trap irregular pockets of gas within the melt.

Using multiple small charges instead of one large charge may provide time for bubbles within the melt in the region around the embedment to migrate to the surface and dissipate before being trapped in the polymerized material. As the material polymerizes, it may become more viscous, effectively inhibiting interior bubbles from escaping. The small multiple layers may slow down the polymerization process on the inside layers of the melt relative to the outside layers, allowing the material to remain soft enough for the bubbles to escape.

In particular, for a cross-linked high-density polyethylene (XHDPE) material, there may be added peroxide off-gassing bubbles resulting from the molecular polymerization. These gas bubbles may be trapped in the melt and collect around nucleation sites, which may present themselves as mold surface defects and contaminant in the melt. The foreign object may be viewed as essentially a giant nucleation site for bubbles, and hence can create large voids in the resulting product. Controlling relatively thin layers of molding material on both sides of the foreign object may ensure uniform heat application and control. Forming multiple thin layers may also assist the trapped air and, for XHDPE, peroxide bubbles in their migration to the surface, improving the cosmetics of molded product with the foreign object.

In addition, multiple layering may allow each layer to have a different color and/or a varying degree of opacity. For example, one or more layers may be formed of an opaque material, making a normally translucent product into an opaque product. This may be beneficial to the chemical industry, where a particular color is required on the external surface of a container product for chemical identification purposes while blocking ultraviolet light penetration, which may diminish or destroy the contents inside the container product. In this case, the outermost layer can be used to have the specific color for chemical identification, and an interior or innermost layer can be used to block damaging ultraviolet light. Further, the innermost layer may be formed of a food-grade material, where the outside layers may include a UV-inhibitor and/or a material with better mechanical property than the innermost layer.

Moreover, the individual layers can be variable in thickness and in color. The bonding between layers may be achieved by applying heat for the appropriate length of time depending upon the volume of powder material added for that respective layer. The multi-layered and colored wall may also create a unique cosmetic affect when the finished product is post-machined to amplify the color differences hidden within the wall.

In addition, the individual layers may be formed of materials with differing durometers to provide, for example, acoustic and vibrational dampening of the interior contents. For example, a softer material may be sandwiched between two harder layers to provide acoustic and vibrational dampening between the two harder layers.

According to another exemplary aspect, a method of controlling the timing of one or more subsequent charges of powder materials is disclosed herein. Proper bonding of the numerous layers may require that the subsequent charges are added according to a schedule at a specific time. The subsequent charges may be added at as close to its melting temperature as possible in order to keep the melt soft enough for the bubbles to escape.

FIG. 2 schematically illustrates an exemplary method of controlling the timing of multiple charges of powder materials. There may be four main stages that a mold material may undergo during a rotational molding process: powder consumption (tacking); coalescence (sintering); densification (defoaming); and solidification (crystallization). The mold material at each of these stages may have unique rheological characteristics.

In step S30, a first powder charge may be added into the mold, and heat is applied to the mold to form a first layer. Before a second powder charge is added, the first powder charge may need to be fully consumed, and sintering (e.g., coalescence) of the first layer may need to be completed or just completed.

For example, a second powder charge may be added at a predetermined time (e.g., one or two minutes) into densification (e.g., defoaming stage), so that any bubbles existing in the first layer may have adequate time to be pushed ahead of the first layer around the foreign object and dissipate. At this time, the first layer is still viscous since polymerization has not yet been completed, and the subsequent powder charge can be added (step S32). The term “polymerization,” as used herein, refers to a process of reacting monomer molecules together in a chemical reaction to form polymer chains of three-dimensional networks.

The second powder charge may tack onto the sintered surface of the first layer and increase to the glass transition temperature. The bubbles from the first layer may continue migrating through the second layer as it continues melting and begins sintering. When the second layer has fully sintered and is defoaming, the third powder charge may be added to form a third layer (step S34) and so on. The last layer may be heated longer and at as low a temperature as possible to give the bubbles time to migrate to the surface of the last layer and to allow the molding material to densify into a monolithic composite structure and complete the polymerization (steps S36-S40).

When the rotational molding process is completed, the foreign object may be fully encapsulated inside a wall of the finished rotationally molded product. FIG. 3 is a cross-sectional view of an exemplary finished, rotationally molded product 10 made consistent with the exemplary methods described above. As shown in the figure, the foreign object 5 is fully encapsulated inside a wall 8 of product 10 on all sides. Because the disclosed methods do not require a secure mounting feature within the mold, foreign object 5 does not have any of its portion being exposed externally. It also allows foreign object 5 to be located anywhere that it fits geometrically in product 10. Product 10 also presents reduced, minimal, or no cosmetic indication of the location of the foreign object from the outside surface.

According to still another exemplary aspect, a method of preparing an electronic device for encapsulation into a rotationally molded product is disclosed. Most electronics are sensitive to heat, shock, and/or vibration. For example, the discrete components on a printed circuit board (PCB) themselves can often survive high temperatures, but the differences in the thermal expansion coefficient with adjacent materials often result in excessive stress, causing broken solder joints and cracks in component cases. The rotational molding process involves high heat for extended durations and, therefore, electronics usually cannot be directly embedded into the walls of a rotationally molded product. Further, because electronics require power to function, batteries need to be included in the electronic devices. However, batteries can expand and contract up to 15% with the regular charging cycle and temperature fluctuations. Therefore, this dimensional oscillation should be accommodated in the preparation of an electronic device for embedment into a rotationally molded product. Further, batteries or the discrete components on a PCB typically should not come in direct contact with the molding material to minimize damaging the batteries and the electronics.

To fully encapsulate an electronic device with a power source, the present disclosure provides a method for preparing the electronic device for encapsulation. The disclosed method may generally involve pre-potting of the electronic device and multi-layered stiffening lamination to protect the electronic device from direct exposure to the molding material during a rotational molding process.

FIG. 4 schematically illustrates an electronic device 30 prepared for encapsulation, according to one exemplary embodiment of the present disclosure. For illustration purposes only, electronic device 30 includes a plurality of discrete electronic components placed on a printed circuit board 32. Electronic device 30 is pre-potted with a suitable potting material 35, such as a soft durometer material. An example of such a material includes epoxy adhesive, such as, for example, Scotch-Weld™ DP-150 manufactured by 3M. Pre-potting may serve to accommodate the differences in the thermal expansion coefficient that may occur during heat exposure in a rotational molding process. Pre-potting may also serve to create a more uniform dimensional profile by blending the dimensional variations from the components on printed circuit board 32.

Potting material 35 may be enclosed in a stiffening enclosure 38. Enclosure 38 may be custom-designed around the unique components of the electronic device and integrated with physical features of the electronic device being rotationally molded. Enclosure 38 can be fabricated from fiberglass fabric of varying weaves and weights, as well as carbon fiber cloth, aramid fiber cloth, or variations and combinations thereof. One of the purposes of enclosure 38 may be to pre-encapsulate the electronics and provide a stiffening laminate. Enclosure 38 may also create additional stiffness and rigidity in the rotationally molded product where it is located.

In some exemplary embodiments, batteries may be prepared differently than a printed circuit board due to their specific operational and material characteristics. For example, it may be beneficial to provide adequate spacing around the batteries to allow the batteries to expand and contract within the enclosure or the finished mold. The batteries may also be electrically insulated from one another while provided with suitable electrical connections (e.g., wires) to each other and to other electronic components.

The enclosure for batteries may depend upon the form factor of the batteries themselves. For example, cylindrical batteries may be oriented co-axially to make a battery stick, which may be located in the molded product near an edge or rib feature, which can accommodate the shape more easily. Electrical connectivity may be achieved using a flexible printed circuit board fabricated from a polyimide film, such as, for example, Kapton developed by DuPont. Coin cell batteries can be oriented flat in the same enclosure as the PCB, using a suitable substrate, such as G11 substrate, to provide dimensional stiffness. By way of example only, in some exemplary embodiments, a fine weave fiberglass fabric of about 5 ounces per square yard may be applied around the printed circuit board and battery stick, followed by several more layers of the same or different fiberglass fabric.

After the electronic device is enclosed, the enclosed device may be sanded to smooth out rough edges and blend the enclosure. A custom mold and vacuum bagging technique may be employed to lay-up the enclosure to ensure no bubbles are trapped inside the enclosure. For example, the enclosure may be saturated with a liquid thermoset polymer, such as, for example, polyester, vinyl ester, or epoxy resins to form a laminate. The saturation process can be carried out either manually from a resin container or using a spray gun that dispenses the resin and/or curing agent mixture. The laminate may then be rolled out in a laminating tool to form a consolidated enclosed device. The prepared enclosure may be embedded into a wall of a rotationally molded product through a conventional or non-conventional rotational molding process, which results in no, minimal, or reduced cosmetic indication of its location.

The disclosed exemplary methods for preparing an electronic device for encapsulation may provide various advantages. For example, the exemplary methods may accommodate a wide variety of battery shapes, such as cylindrical, rectangular, flat, circular, etc. Since batteries need to withstand the high temperatures required in the rotational molding process for the specific molding material used, properly preparing the batteries with a suitable potting material and an enclosure to accommodate various battery shapes may ensure that the batteries can stay in temperatures below their tolerance level and not be directly subjected to higher temperatures required in the rotational molding process.

In addition, the disclosed method can accommodate a wide variety of printed circuit board configurations. While printed circuit boards may come in many different shapes, sizes, and thicknesses, enclosing the boards with customized enclosures and potting material according to the disclosed exemplary methods may help maintain the structural and operational integrity of the printed circuit boards. Moreover, an embedment with an enclosure may create additional stiffness and rigidity in the rotational molded products where it is located. This may help prevent distortion and warpage at portions near the embedment.

In accordance with still another aspect, an exemplary oven-less rotational molding machine with the capabilities to control the heating and/or cooling of various local zones of the mold is disclosed with reference to FIGS. 5-7. For example, as will be detailed herein, the physical locations of various heating and/or cooling zones of the mold can change within the same physical mold during a rotational molding process for a single product. In some exemplary embodiments, the heating and/or cooling profiles applied to these zones may dynamically change depending upon live feedback from the mold. The capability to dynamically control the temperatures of various locations of the mold may translate into a sufficient control over the rheological behavior of the mold material inside the mold so as to create various wall thicknesses within the same molded products.

In the rotational molding industry, carousel rotational molding machines are the most widely used machines for rotational molding. A carousel machine typically includes three or four hollow molds each connected to a spinning armature. Each mold may be rotated on the spinning armature, which may also rotate a mold mounting plate in an axis perpendicular to the rotating axis of the spinning armature. This creates a dual-axis rotation for even powder distribution in the mold. The armatures may be fixed to a central turret, which rotates the armatures to sequentially place each mold in one of three or four process stations, including a loading/unloading station, a heating station, and a cooling station. If four process stations are used, the cooling station may have two separate cooling stations, such as, for example, a natural convection station and a forced convection station. The heating station is generally a large furnace oven applying heat to the mold. An operator of the machine may program the oven temperatures and cycle times, as well as the armature and plate speeds using a computer control station.

These carousel-type rotational molding machines, however, do not allow different regions of the mold to be heated and/or cooled independently of each other. All heating and cooling is applied uniformly to the entire mold as it enters the oven or cooling station. As a result, to vary the interior surface temperature of the mold in these machines, the mold itself may need to be modified to vary its thicknesses, add one or more heat pins in the mold, and/or pre-heat or pre-cool a specific region of the mold.

FIG. 5 shows an oven-less rotational molding machine 40 according to one exemplary embodiment of the present disclosure. Unlike the carousel machines discussed above, molding machine 40 does not require an oven as a heat source and is instead configured to directly heat and/or cool a mold.

As shown in FIG. 5, molding machine 40 includes a mold 60 configured to rotate in a holding frame 58 and a support stand 52 rotatably supporting holding frame 58. Mold 60 may include a shaft (not shown) rotatably connected to holding frame 58 via a suitable coupling mechanism (e.g., a slip ring 51) that allows rotation of mold 60 relative to holding frame 58. Holding frame 58 may include a pair of projections (not shown) extending from opposite lateral sides of holding frame 58 to rotatably connect to a portion of support stand 52 via a suitable coupling mechanism (e.g., a slip ring 59) for rotation about the axis of the projections.

Molding machine 40 may be configured to rotate mold 60 and holding frame 58 in two rotational directions that are perpendicular to one another. For example, molding machine 40 may include a first electric motor 54 configured to rotate mold 60 in a first rotational direction indicated by arrow 53 in FIG. 5 and a second electric motor 56 configured to rotate holding frame 58 in a second rotational direction indicated by arrow 57. First and second rotational directions 53 and 57 may be substantially perpendicular to one another. A separate controller may be provided for each of first and second electric motors 54 and 56 to individually control the rotational speed of each of first and second electric motors 54 and 56.

As mentioned above, molding machine 40 may be configured to allow its mold 60 to be directly heated and/or cooled through multiple heat sources and/or heat sinks. For example, heat can be applied to mold 60 using any combination of resistive (e.g., nichrome) wires, cartridge heaters, resistors, infrared heating, heating liquid, and/or flames. Cooling can be achieved using any combination of gaseous or liquid forced convection (e.g., a fan), natural convection, and particular mold design (e.g., material selection, mold thickness, etc).

With reference to FIG. 6, an exemplary embodiment of mold 60 that may enable creating specific heating and/or cooling zones or otherwise enable creating varying temperature profiles within the same mold is described herein. The body of mold 60 in FIG. 6 is shown translucent to illustrate an exemplary heater arrangement inside mold 60. As shown in FIG. 6, mold 60 may be formed of an upper body 63 and a lower body 67. Upper body 63 and lower body 67 may be joined together via one or more suitable connecting members 66 to form mold 60. Mold 60 may also include a vent tube 68 communicating between the interior and exterior of mold 60 to stabilize the pressure inside mold 60.

Each of upper body 63 and lower body 67 of mold 60 may define a plurality of channels each configured to receive an individual heat and/or cooling source. The channels may include horizontal channels for receiving horizontal cartridge heaters 61 and vertical channels for receiving vertical cartridge heaters 62. Cartridge heaters are exemplary only, and any other types of heaters and/or coolers may be used alternatively or additionally. Each of the channels may include an opening 65 opening out to the external surface of mold 60 to receive respective horizontal heater 61 or vertical heater 62. In the embodiment shown in FIG. 6, openings 65 may be formed on sloped edges of mold 60, such that each opening 65 may define an inlet for both the vertical and horizontal channels.

Horizontal and vertical heaters 61 and 62 may be individually controlled throughout a rotational molding process. Accordingly, each heater 61 or 62 may create a separately controllable heat zone in mold 60. By way of example only, each of upper body 63 and lower body 67 may include 51 channels. In some exemplary embodiments, two or more heaters 61 and 62 may be grouped and controlled together or independently to create a common heat zone.

Various thermal sensors (not shown) may be installed within the walls of mold 60 near the interior surface of the mold. These sensors may detect and feed live temperature information or readings to a controller (not shown) during the rotational molding process. Specific heating and cooling zones and temperature profiles may be programmed in the controller to support any manufacturing specifications (i.e., an embedment, a stiffening rib, wall thickness variations, etc.). The number of heating/cooling zones may be adjusted as needed without re-wiring or physically adjusting mold 60 itself. The heating and cooling cycle durations may be dynamically adjusted according to the temperature data measured during the operation. The zones themselves are flexible for the different cycles within the process. For example, the quantity and geometric configuration of the heat zones do not need to correspond to the quantity and geometric configuration of the cooling zones within the same mold. Also, if there are several heat cycle steps during the process, the quantity and geometric configuration of the heat zones for each of the heating cycles can vary within the same mold.

For example, during the plastic accrual phase of the heating cycle, a specified zone may be set to a higher temperature than the adjacent zone. This may result in more powder accrual in that higher heat region. After the powder bed is fully consumed, the unique heat zone may be eliminated, and mold 60 may be uniformly heated and cooled for the duration of the process. Depending upon the resolution of heat zones within mold 60, stiffening rib features may be fabricated for each rotational molded unit without requiring a new mold. In another exemplary embodiment, there may be only one heat zone for mold 60 during the plastic accrual phase of the heating cycle, but during sintering and coalescing a unique cooling zone around a sensitive electronic embedment can be initiated. After densification, the unique cooling zone may be eliminated, and once again the process can be completed with uniform heating and cooling.

This flexibility in temperature control during a rotational molding process may allow optimization of process time and proper control of the rheology of the various plastic states during the process. This highly configurable and dynamic control of mold temperature at the interior surface may also provide a rheological control of the polymer melt, which may allow creating an almost infinite variety of variable wall thicknesses between molded products while using the same mold for fabricating those molded products.

For example, since the amount of molding material accrued on a mold surface is generally proportional to or approximately depends on the temperature applied, the capability to control the temperatures at various locations of a mold surface makes it possible to vary the wall thicknesses at various locations of the molded product, as shown in FIG. 7. FIG. 7 schematically illustrate that the wall thickness can be controlled by controlling the amount of heat applied to specific regions of the mold. Variations in the applied heat may represent variations in the applied temperature, duration, and/or the combination thereof. As shown in the figure, applying heat amount (Heat A) in region A of the mold surface may result in a one-time (i.e., “lx”) wall thickness of the molding material accrued on the mold surface, while applying region B with heat amount (Heat B), substantially greater than Heat A applied in region A, may result in a thickness six-times (i.e., “6×”) greater than that of region A. In region C, applying heat amount (Heat C), which is between Heat A and Heat B applied respectively to region A and region B, may result in a thickness twice (i.e., “2×”) the thickness of region A.

The flexible and dynamic temperature control may also allow a wide variety of practical applications. For example, such temperature control may allow foreign objects (e.g., electronics) to be added to the melt and cosmetic blending of the foreign objects into the walls of the rotationally molded product. The melt flow characteristics may determine the uniformity and blending of the mold material accrual over the foreign objects.

The temperature control of molding machine 40 can also control the resulting polymer morphology of the finished molded product. The degree of polymerization (e.g., percentage of cross-linking) achieved is a function of heat exposure over time. Molding machine 40 may lower the temperature substantially while still controlling the degree of polymerization, resulting in optimization of the mechanical properties of the molded product.

The temperature control of molding machine 40 can also reduce fabrication time and/or cost. For example, a typical rotational molding process uses a furnace to supply heat to a large oven. The heat is then transferred from the heated air in the oven to a mold placed therein by convection. The furnace, typically not sealed well, needs to be powerful enough to keep the oven at an operational temperature (e.g., 650° F.) or other temperature, depending upon the mold material, for a long duration of process time. This heating process with the furnace and oven may be inefficient, take too much time, and result in high fuel costs for operating the furnace. Therefore, directly heating mold 60 via conduction in molding machine 40 not only eliminates the need for a furnace to heat a large oven but may also shorten the processing time, resulting in reduced fabrication time and/or cost.

Further, the temperature control of mold 65 in molding machine 40 may reduce the risk of over- and under-heating the rotationally molded product. For example, the mold temperature can be controlled near a foreign object being embedded to prevent over- or under-heating of the mold material in that heat sink region.

According to yet still another aspect of the present disclosure, a rotational molding machine, such as molding machine 40 described above with reference to FIGS. 5 and 6, may include an apparatus for regulating the pressure and temperature inside a mold during a rotational molding process.

During a typical rotational molding process, as the mold is heated and cooled, the gas inside the mold expands and contracts during the heating and cooling. This creates fluctuations in pressure inside the mold. To stabilize the pressure in the mold, a vent tube may be positioned in the mold (e.g., along the parting line between the upper and lower shells of a clamshell mold). The vent tube may be filled with a loose porous fiberglass filler, allowing the gas to move in and out of the mold while preventing the powder inside the mold from falling out during rotation.

The temperature inside the mold may be measured using an insulated data acquisition unit mounted to the rotating mold and hard-wired thermocouples may be placed inside the mold, hanging free in space, or on the inside or outside surface of the mold. Having the thermocouples in good contact with the surfaces being measured during the process may be a challenge. The thermocouple measurements obtained using these methods can be inaccurate or erroneous if the powdered material accrues over the top of the thermocouple during the process or if the thermocouple moves and adheres to a wall instead of remaining in free space in the mold.

FIG. 8 illustrates an exemplary system 80 for regulating the pressure and temperature inside mold 70 during a rotational molding process so as to dynamically control the internal air pressure and temperature throughout the process. System 80 may be considered a passive system because it does not include any active pressure or temperature regulator. System 80 may include a vent plug 82 filled with a filler 81. Any suitable material known in the art may be used for filler 81. System 80 may also include an outlet pipe 84 extending from filler 81 of vent plug 82 to the atmosphere and an inlet pipe 86 extending from the atmosphere to interior space 75 of mold 70. A check valve 87 may be disposed on inlet pipe 86 to allow only the inlet of air from the atmosphere to interior space 75. One or more pressure sensors 83 and/or thermocouples may be positioned within filler 81 of vent plug 82 and/or outlet pipe 84.

A pressure regulation valve 85 may be disposed in outlet pipe 84 to regulate the pressure inside mold 75. Regulation valve 85 may be configured to open at an upper set pressure and close at a lower set pressure. The upper set pressure and the lower set pressure may define the pressure range at which mold 70 is to be operated. For example, if the pressure inside mold 70 increases above the upper set pressure, regulation valve 85 may open and release the gas inside mold 70 to the atmosphere via outlet pipe 84. Regulation valve 85 may close when the pressure inside mold 70 falls below the lower set pressure. If, on the other hand, the pressure inside mold 70 decreases below the lower set pressure, inlet pipe 86 may be configured such that air may flow into interior space 75 of mold 70 from the atmosphere. In some exemplary embodiments, the pressure inside mold 70 can be varied during a rotational molding process by varying the upper and lower set pressures of regulation valve 85.

As the pressure inside mold 70 fluctuates from the expansion and contraction of the gases therein, these fluctuations may be measured and stored using a data acquisition unit. The collected data may be used to optimize the process durations and temperatures.

Having the ability to accurately measure the temperature and pressure of the interior gas throughout the rotational molding process may enhance the optimization of the process. It may reduce the cycle time, prevent over- and under-heating of the product, and reduce stress in the molded products.

FIG. 9 schematically illustrates another exemplary embodiment of a pressure and temperature regulation system 90. System 90 may differ from system 80 in that it incorporates an active pressurization system 92 and a mold material distribution system 95 into an inlet pipe 96.

For example, active pressurization system 92 may include a pneumatic fluid delivery system (e.g., a pump) configured to deliver pressurizing fluid to mold 70 upon detecting a predetermined activation condition inside mold 70 to dynamically regulate the pressure and temperature inside mold 70. Mold material distribution system 95 may include one or more material chutes or containers each containing different mold powder material to be delivered into mold 70. Each chute contains one or more specific materials and is connected to inlet pipe 96 with a valve (e.g., gate valve) that may be opened and closed by a controller.

Pressurization system 92 and/or mold material distribution system 95 may be wired directly to a control system of the molding machine or the regulation system 90 to control the temperatures and pressures, as well as the process durations, corresponding to the specific process characteristics of the individual product being fabricated

If a multi-layer process, such as those described above with reference to FIGS. 1 and 2, is being performed, the controller may operate the valves of distribution system 95, either manually or automatically according to a pre-programmed routine, to add one or more additional charges of layer materials at the optimum time in the heating cycle, hold it for a proper duration, and maintain the internal temperature and pressure at a desired level in order to achieve the proper cosmetic affect and proper bonding between multiple layers.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

What is claimed is:

1. A method of encapsulating a foreign object in a rotationally molded product, comprising:
forming a pre-layer on a surface of a mold of a rotational molding machine;
placing a foreign object on the pre-layer;
loading a first charge of powder material in the mold; and
rotating the mold while applying heat to the mold to form a first layer on the foreign object,
wherein the foreign object is fully encapsulated between the pre-layer and the first layer.

2. The method of claim 1, wherein forming the pre-layer comprises:
applying a powdered pre-layer material to a region of the mold at which the foreign object is to be placed; and
heating the powdered pre-layer material to form the pre-layer on the region of the mold.

3. The method of claim 2, wherein the powdered pre-layer material and the first charge of powder material are substantially the same material.

4. The method of claim 1, further comprising, after placing the foreign object on the pre-layer, applying a fixing layer on a portion of the foreign object to fix the foreign object onto the pre-layer.

5. The method of claim 4, wherein applying the fixing layer comprises:
applying a powdered fixing layer material to an edge or corner of the foreign object; and
applying heat to the powdered fixing layer material applied to the edge or corner.

6. The method of claim 5, wherein the powdered fixing layer material and the first charge of powder material are substantially the same material.

7. The method of claim 1, further comprising loading a second charge of powder material to the mold to form a second layer above the first layer.

8. The method of claim 7, wherein loading the second charge of powder material occurs after the first layer has completed sintering but prior to a completion of polymerization so as to allow bubbles in the first layer to migrate.

9. The method of claim 7, wherein the first charge of powder material and the second charge of powder material are different from each other.

10. The method of claim 1, further comprising enclosing the foreign object with an enclosure and substantially filling the enclosure with a potting material.

11. The method of claim 10, wherein the enclosure comprises fiberglass fabric.

12. A rotationally molded product comprising:
a wall; and
a foreign object fully encapsulated within the wall without any portion being exposed externally through the wall.

13. The product of claim 12, wherein the foreign object comprises an electronic device.

14. The product of claim 13, wherein the foreign object comprises an enclosure substantially enclosing the electronic device.

15. The product of claim 14, wherein the enclosure is filled with potting material.

16. The product of claim 12, wherein the enclosure comprises a multi-layered stiffener configured to protect the electronic device.

17. The product of claim 12, wherein the foreign object comprises an opaque material.

18. An oven-less rotational molding machine comprising:
a molding platform rotatably received in a housing frame;
a mold disposed in the molding platform; and
a heater disposed in the molding platform to apply heat to at least a portion of the mold.

19. The machine of claim 18, wherein the heater is configured to heat different portions of the mold with different temperature profiles.

20. The machine of claim 18, further comprising a plurality of thermal sensors installed within or on the walls of the mold to measure a temperature of the mold.

21. The machine of claim 18, further comprising a cooler disposed in the molding platform to cool at least a portion of the mold.
